(19) United States
(12) Patent Application Publication
(10) Pub. No.: US 2012/0153240 A1
(43) Pub. Date: Jun. 21, 2012

(54) SCALABLE NANOSTRUCTURED THERMOELECTRIC MATERIAL WITH HIGH ZT

(75) Inventors: Wei Luo, Tustin, CA (US); Zhigang Lin, Irvine, CA (US)

(73) Assignee: AEGIS TECHNOLOGY, INC, Garden Grove, CA (US)

(21) Appl. No.: 12/972,519

(22) Filed: Dec. 20, 2010

(51) Int. Cl. H01B 1/06; H01B 1/00; B02C 23/18; B82Y 99/00

(52) U.S. Cl. 252/519.4; 241/18; 252/500; 977/762; 977/932

(57) ABSTRACT

Various embodiments of the present invention create a cost-effective process that improves ZT value while enabling the TE materials to be scaled-up for mass production. Several embodiments of the invention include a thermoelectric material comprised of nanopowder and a nanomaterial. The nanomaterial may be in the form of a nanowire, nanofiber, nanotube, nanocrystal or similar form or combination of forms. Other embodiments include a method of creating a thermoelectric material through mixing and consolidating the nanomaterial and nanopowder into a solid. Additional embodiments may involve a thermoelectric module with P and N type semiconductors of the nanomaterial and nanopowder.

### STATEMENT REGARDING FEDERALLY SPONSORED RESEARCH OR DEVELOPMENT

Certain work described herein was supported by SBIR grant no. DE-FG02-07ER86296. The Government may have certain rights in this invention.

### CROSS-REFERENCE TO RELATED APPLICATIONS

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

(1) Field of the Invention

The field of the invention relates to thermoelectric materials.

(2) Description of Related Art including Information Disclosed under 37 CFR 1.97 and 1.98

Thermoelectric (TE) materials are a class of materials that can efficiently convert between thermal energy and electrical energy. Only certain materials have been found usable with this property.

Thermoelectric (TE) materials are useful in many applications. With TE materials, electricity can be employed to dissipate heat (thermoelectric coolers) or waste heat can be utilized to generate electricity (thermoelectric generators). Additionally TE devices have the advantage of no moving parts and thus are quiet, requiring little maintenance. Therefore, TE materials are useful in a wide variety of general applications such as refrigeration and power generation as well as niche applications such as cooling IR sensors, laser diodes and computer electronics, and powering space probes.

However, the TE properties of these devices have been insufficient for broader application such as absorption chillers which capture waste heat and then recycle the waste heat for industrial refrigeration.

The low efficiency of TE devices is due to a low value of the basic materials' figure-of-merit, ZT. Current state-of-the-art commercial TE materials can only achieve a ZT value of around 1. However, a conventional chiller or a waste heat recovery device would requires a ZT of 2-3. The figure of merit, ZT, is conventionally defined as:

ZT=S²σT/(κₑ+κ_{L})

where S is the Seebeck coefficient, σ is the electrical conductivity, and κₑ and κ_{L} are the electronic and lattice components of the thermal conductivity, respectively. The difficulty in a high ZT lies in the fact that large values of ZT require high S, high σ, and low (κₑ+κ_{L}) simultaneously. Since an increase in S normally implies a decrease in σ because of carrier density consideration, and since an increase in σ implies an increase in κₑ as given by the Wiedemann-Franz law, κₑ/σ=LₒT (Lₒ, Lorentz number), a good thermoelectric material should at least have low lattice thermal conductivity to prevent thermal shorting.

Current thermoelectric materials are almost exclusively based on the skutterudite material system. These materials have heavy constituent atom masses, low electronegativity differences between the constituent atoms and large carrier mobility, which forms the basic conditions for high ZT values. A number of novel skutterudite materials have been explored with progressively larger ZT values. For example, researchers have experimented with the ZT of AgPb₁₀SbTe₁₂, and have achieved a ZT value of ˜2.2 at 800K. K. F. Hsu, S. Loo, F. Guo, W. Chen, J. S. Dyck, C. Uher, T. Hogan, E. K. Polychroniadis, and M. G. Kanatzidis, “Cubic AgPbₘSbTe₂₊ₘ: Bulk Thermoelectric Materials with High Figure of Merit,” Science, vol. 303, pp. 818-821, 2004. However, these materials are still unsatisfying in meeting the required ZT values for a new generation of cost-effective thermoelectric coolers where ZT>2 at 300K and ZT>3 at 600-800K.

Alternatively, new direction to achieve high ZT values may come from low-dimension materials on account of the quantum confinement effects. Substantial enhancements in thermoelectric efficiency are predicted in quantum-confined systems because this confinement produces peaks in the density of states that provide the enhancement effects. This strategy can offer opportunities to increase the boundary scattering of phonons at the barrier-well interfaces without as large an increase in electron scattering at the interface, and hence could realistically provide the resultant thermoelectric materials with a high ZT with a range of 2-3 at room temperature. For example, a superlattice nanowire design concept consisting of interlaced nanodots of two distinctive constituents, may achieve a ZT value of more than 3 (may up to 6 or more) in PbTe/PbSe system. Y.-M. Lin and M. S. Dresselhaus, “Thermoelectric Properties of Superlattice Nanowires,” Phys. Rev. B, vol. 68, pp. 075304/1-14, 2003.

However, it is still difficult and cost prohibitive to synthesize the pure quantum confined materials (0D, 1D and 2D) into a bulk material essential to form practical TE systems capable of producing sufficiently strong power generation or energy harvesting.

Additional information relevant to attempts to address these problems can be found in U.S. Pat. Nos. 5,973,050, 6,225,550, 6,342,668, 6,605,772, and U.S. Patent Publication Nos. 2006/0102224, 2006/0118158, 2007/10131269. However, each one of these references at least suffers from one or more of the following disadvantages: lower ZT, cost inefficiency and narrow applicability.

All referenced patents, applications and literatures are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply. The invention may seek to satisfy one or more of the above-mentioned desire. Although the present invention may obviate one or more of the above-mentioned desires, it should be understood that some aspects of the invention might not necessarily obviate them.

### BRIEF SUMMARY OF THE INVENTION

Accordingly, an object of the present invention is to create a cost-effective process that improves the ZT value while enabling the TE materials to be scaled-up for mass production.

Embodiments of the present invention include creating a thermoelectric material comprised of nanopowder and a nanomaterial that includes at least one form selected from the group consisting of nanowires, nanofibers, nanotubes, or nanocrystals. In certain embodiments of the invention, the nanomaterial may include up to and including 50% of the thermoelectric material. In additional embodiments, both the nanomaterial and nanopowder includes at least one thermoelectric material.

Numerous embodiment of the invention include a method of creating a thermoelectric material that includes a nanomaterial and a nanopowder, mixing the nanomaterial and nanopowder and consolidating the mixture into a solid. The nanomaterial may include at least one form selected from the group consisting of nanowires, nanofibers, nanotubes, or nanocrystals. The nanomaterial may but need not be chemically synthesized. Also, the nanopowder may but need not be created by high energy ball milling.

Further embodiments of the invention include a thermoelectric module including a P and N type semiconductor. The P and N type semiconductor is composed of a nanomaterial including nanopowder and at least one form selected from the group including nanowires, nanofibers, nanotubes, and nanocrystals.

In various embodiments of the invention, highly-oriented PbSe-nanowires (quantum-confined materials) are introduced into PbTe bulk nanocrystalline materials to form a high-ZT thermoelectric nanocomposite. This nanocomposite can be processed with a cost-effective in-situ Self-Assembly and Wire-Alignment process followed by a conventional hot-press consolidation. In this type of nanowire-bulk material, the electron can be freely transported since both PbSe and PbTe possess similar bandgap, overcoming the potential bar in the transportation of phonons due to the wire-shell structure and thus provide the high ZT values that will enable the production of high-efficiency TE devices. Although the nanowire-enhanced composite may have a lower ZT than that of a theoretically best or purely “ideal” nanowire structure with a higher ZT, the nanocomposite can be implemented with a cost-effective process to produce a bulk-size TE material, while the purely “ideal” nanowire structure is impractical to implement for bulk or mass production.

Thereby, this microstructure design and processing is superior to any current method used to fabricate nanocomposites such as mechanical blending and co-precipitation that do not offer the ability to retain the nanostructural order in the bulk phase. Table 1 provides a comparison of the ZT of PbTe based systems. By using an effective medium type method to model the behavior of the proposed nanowire-enhanced composites, the ZT of such material is as high as 3 at 300K if the fraction of nanowires in the composite is 20 (at) %, as listed in Table 1. Also, a higher ZT is expected if a greater percentage of nanowires are incorporated into the composite.

TABLE 1
Comparison of ZT of PbTe-based systems

| Types of PbTe based systems | PbTe-based ZT | |
|---|---|---|
| Bulk (exp.) | ~0.4^{a} | (at RT); |
| | ~1^{b} | (max) |
| Quantum well (exp.) | 0.95 for 6.7 nm; | |
| | 1.25 for 4.2 nm (at 570 K)^{c} | |
| Quantum Dot superlattices (exp.) | ~2^{d} | (at 300 K) |
| Superlattice nanowires (cal.) | >6^{e} | (at 77 K) |
| Presently enhanced-bulk-composite (cal.) | ~3 | (at 300 K) |

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 illustrates the relationship between nanowire diameter to the figure of merit, ZT at various temperatures in an ideal case from literature values.

FIG. 2A illustrates a thermoelectric module adapted for thermoelectric power generation by using an n-type and a p-type semiconducting material.

FIG. 2B illustrates a thermoelectric module adapted for thermoelectric refrigeration by using an n-type and a p-type semiconducting material

FIG. 3A illustrates a conceptual design of a unit TE module.

FIG. 3B illustrates an infrastructure of a TE module typical of a high power, high density module.

FIG. 4 illustrates a design of a thermoelectric generator for waste heat recovery of exhaust vapor.

FIG. 5A illustrates a number of synthesized PbSe nanowires in an embodiment of the invention.

FIG. 5B illustrates a monolayer assembly of nanowires using a Langmuir-Blodgett technique.

FIG. 6 illustrates a number of synthesized PbSe nanocrystals.

FIG. 7A illustrates a number of cryomilled PbSe particles.

FIG. 7B illustrates a number of cryomilled PbTe—PbSe cluster particles.

FIG. 7C illustrates an EDS analysis of PbTe—PbSe cluster particles.

FIG. 8 illustrates the room temperature thermopower of PbSe as a nanocrystal and as a nanowire as well as PbTe bulk.

### DETAILED DESCRIPTION OF THE INVENTION

The invention and its various embodiments can now be better understood by turning to the following detailed description of the preferred and exemplary embodiments, which are also presented as illustrated examples of the invention defined in the claims. It is expressly understood that the invention as defined by the claims may be broader than the embodiments described below.

### Overview

One embodiment of the invention is a thermoelectric material comprised of nanopowder and a nanomaterial. The nanomaterial may be in the form of a nanowire, nanofiber, nanotube, nanocrystal or similar form or combination of forms.

Another embodiment of the invention is a method of creating a thermoelectric material in which a nanopowder and a nanomaterial are mixed and consolidated. The nanomaterial can be in the form of a nanowire, nanofiber, nanotube, nanocrystal or similar form or combination of forms.

Yet another embodiment of the invention is a thermoelectric module which may have P and N type semiconductors that make use of a thermoelectric material comprised of nanopowder and a nanomaterial. The nanomaterial may be in the form of a nanowire, nanofiber, nanotube, nanocrystal or similar form or combination of forms.

### How the Invention is Used

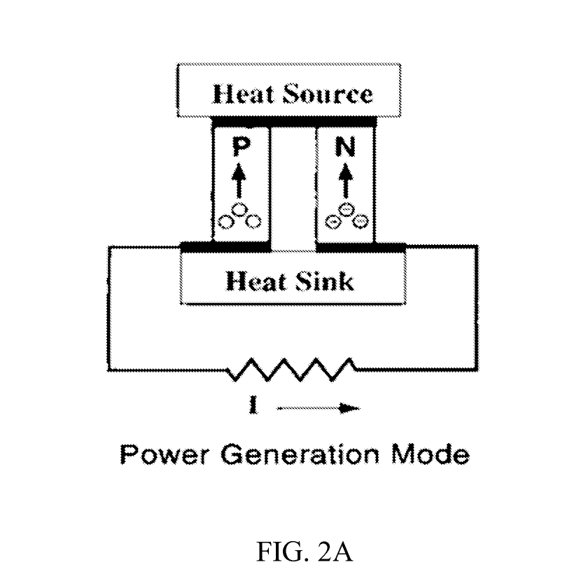

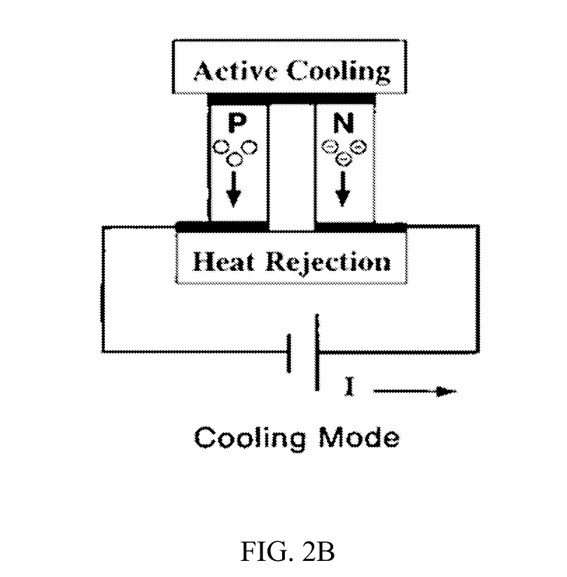

There are many uses for the present invention. One use for thermoelectric materials is for thermoelectric refrigeration or power generation by using a n-type and a p-type semiconducting material. FIG. 2A and FIG. 2B illustrates an example of this type of module adapted from G. S. Nolas, D. T. Morelli, and T. M. Tritt, “Skutterudites: A phonon-Glass-Electron Crystal Approach to Advanced Thermoelectric Energy Conversion Applications,” Annu. Rev. Mater. Sci., vol. 29, pp. 89-116, 1999.

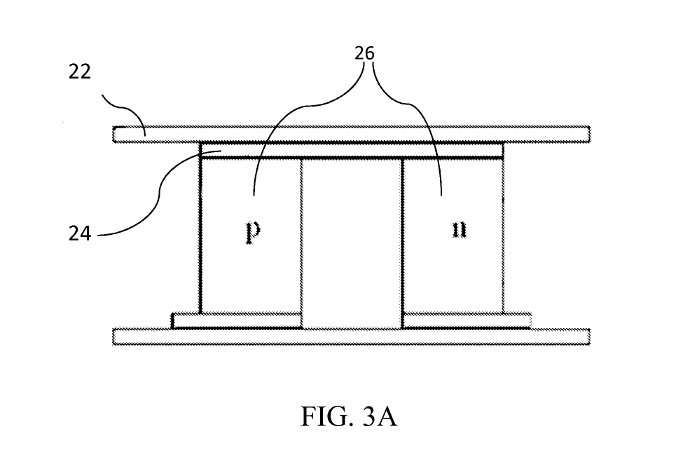

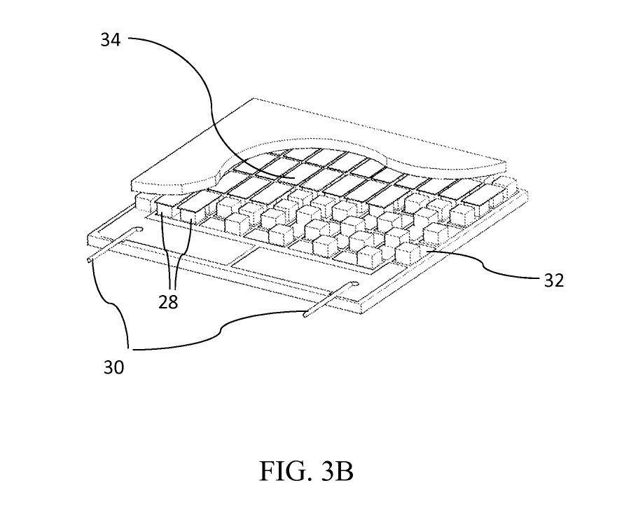

Among the many advantages of the present invention includes the scalability of the thermoelectric material for use at the system level. In principle, a thermoelectric module, either in the form of refrigeration or power generation, uses an n-type and a p-type thermoelectric material. FIG. 3A and FIG. 3B shows a design of typical TE modules. In FIG. 3A, thermoelements (26) are sandwiched between conducting strips (24) which join elements electrically in series. There is a ceramic insulator (22) on top which isolates the module from a heat sink in one application. The module can be a bulk module for high-power refrigeration or power generation, and a thin film module for low power application. For a bulk module, p- and n-type legs are sawn out of bulk materials (ingots), which are then soldered between pre-structured ceramic substrates. As for a thin film device, the substrates or wafers can be patterned with p- and n-type legs (e.g. using a sputtering process) to form low-power thermoelectric devices. FIG. 3B illustrates an infrastructure of a TE module typical of a high power, high density module. Here, P and N type legs (28) are sandwiched between interconnects of a first surface (34) and a second surface (32). The first (34) and second (32) surfaces may have a temperature differential in order to take advantage of the thermoelectric effect. External connections (30) interface with the TE module.

A current difficulty in implementing nanostructured TE materials and TE materials in general is the difficulty in making large-dimension bulk materials (ingots). Currently, only low-power TE devices using nanocrystalline thin film TE material have been used. However, these materials have very limited power levels. Among the advantages of this invention is the creation of TE nanocomposites scalable for large dimensions, which can then be used for high-power TE modules. This high-power, high-power-density TE modulus takes advantages of both the high efficiency of nanostructured materials (resulting in high power density) and the large dimension (bulk) of nanostructured material process (resulting in high power). These technologies can be used for both cooling and power generation devices, and can be adjusted for various leg geometries and device sizes.

Another exemplary use for the present invention is use as waste heat recovery of high temperature vapor fluid. Due to an increasing concern in more-efficiency energy utilization that is often related with the reduction in emission (environmental benefits) and enhancement in system performance, one use is as a thermoelectric generators (TEG) system aimed for applications in waste heat recovery of high-temperature vapor fluid. America's power generations and industrial manufacturing sectors continually vent in the order of 1,000,000 Megawatts of waste heat into the environments, a large percentage of which is in the form of hot vapor. Round or rectangular pipes are two major common conduits in which the waste heat is dissipated. One application is the waste heat recovery of hot exhaust vapor, by utilizing the power generation of thermoelectric devices, in which electrical energy is generated due to a temperature gradient between hot and cold side (Seebeck effect). The power generated from the waste heat can then be transferred for energy storage (battery), a DC fan for cooling, or run other heaters through a power management system (e.g. DC-DC converter for DC output or DC-AC inverter for an AC fan).

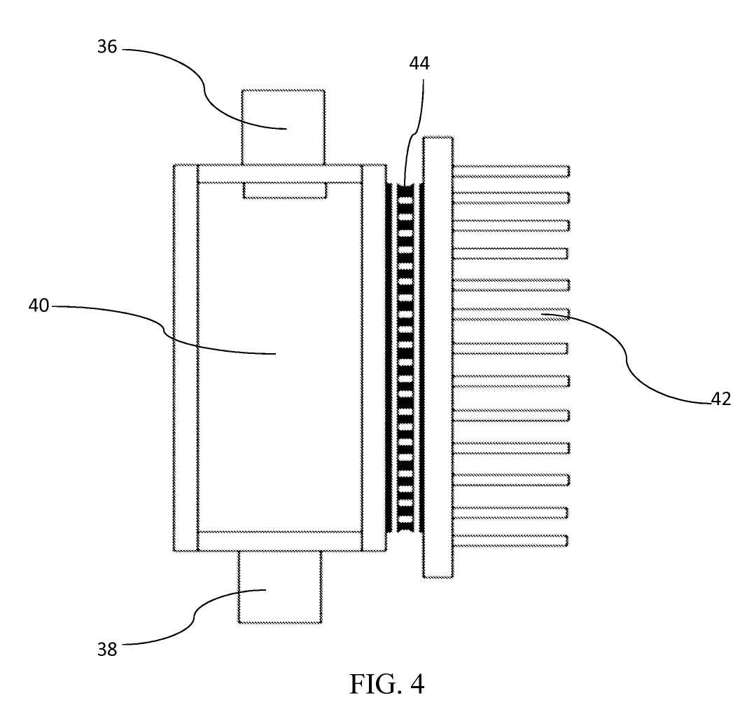

One conceptual design of a TEG for waste heat recovery of exhaust hot vapor is shown in FIG. 4 The TE module (44), which can be mounted on a heat sink, can be integrated with a DC/DC converter with controlled output voltage. Here, the TE module (44) utilizes the thermoelectric effect to harness electrical energy and is connected to a heat sink (42) and exhaust vapor module (40). The exhaust vapor module (40) has both a vapor inlet (38) and an exhaust outlet (36). The thermoelectric effect allows the TE module to generate electricity due to the temperature difference between the hot vapor of the exhaust vapor module (40) and the heat sink (42).

In a TEG system, the efficiency of TEG is dependent on both the efficiency of TE module and the temperature difference. The voltage output of TEG system depends on the voltage of each legs and number of legs

U=N*S*ΔT

Where U is the generated voltage; N are the number of leg pairs; S is the seebeck voltage per leg pair; and ΔT is the temperature difference. Therefore to achieve sufficient output voltage, in addition to have large Seebeck voltage of each leg pair, the system should be able to incorporate a large number of leg pairs (requiring large dimension substrates) and be sustainable under a large temperature difference. The large temperature difference, which however, will generate the large thermal stress, will require a ceramic (or insulated) substrate that has a CTE (Coefficient of Thermal Expansion) matchable with that of thermoelectric nanocomposites material to minimize the thermal stress. However, the CTE of the ceramic substrate generally used (e.g. alumina) has a CTE around 8×10⁻⁶/° C., while the CTE of PbTe or PbTe—PbSe composites are in the range of 19×10⁻⁶/° C. (The CTE of Bi2Te3 is in range of 15×10⁻⁶/° C.). It is thus desirable to use a substrate having the CTE close to TE materials. In addition, high thermal conductivity of the substrate is also desired to minimize the thermal resistance.

Yet another application is on high-thermal-conductivity adjustable composite substrates, which is based on Al-based metal matrix composite (MMCs) with the ceramic-thin-film insulation. This kind of MMCs-based substrate, as compared with conventionally used alumina, has the advantages of high conductivity, adjustable CTE (ranging from 15 to 19×10⁻⁶ depending the composition), and can be processed with large dimensions and a curved configuration to fit pipe applications.

### Features of the Invention

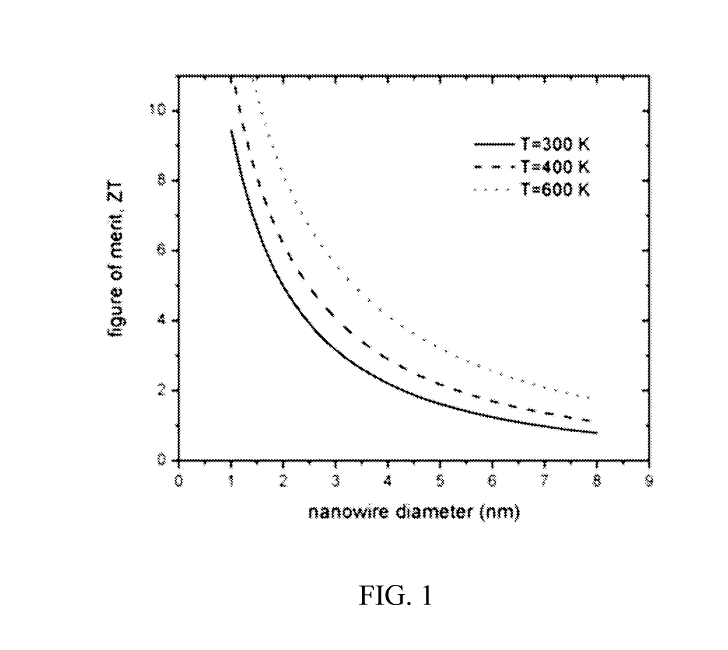

One feature of the invention is nanowire Fabrication through an in-situ Self-Assembly and Wire-Alignment. A precise control over the composition (e.g. doping percentage) and nanoparticle size is necessary for achieving high ZT values. Calculations of ZT for PbTe nanowires based on literature values for the transport parameters of these compounds are shown in FIG. 1, which indicates that ZT values substantial increase with the decrease in the sizes of nanowires. The literature values come from L. D. Hicks and M. S. Dresselhaus, “Thermoelectric figure of merit of a one-dimensional conductor,” Phys. Rev. B vol. 47, 16631, 1993; Y.-M. Lin, S. B. Cronin, O. Rabin, J. Y. Ying and M. S. Dresselhaus, “Transport properties of Bi1-xSbx alloy nanowires synthesized by pressure injection,” Appl. Phys. Lett. vol. 79, 677-679, 2001; and J. Fang, K. L. Stokes, J. A. Wiemann and W. Zhou, “Nanocrystalline bismuth synthesized via an in situ polymerization-microemulsion process,” Mater. Lett. vol. 42, 113, 2000. This kind of calculation demonstrating the enhancement in ZT of nanoscale materials assumes optimum placement of the Fermi level for a given nanostructure size. However, the ZT may decrease considerably if the reduced Fermi energy is not optimum. Furthermore, simply making nanoscale powdered material, by using such techniques as a mechanical milling or a gas-phase synthesis process which produce a broad dispersion of irregularly shape particles, will not yield enhanced thermoelectric properties suitable for manufacturing enhanced TE devices.

Therefore, one embodiment of this invention overcomes this problem with features such as utilizing a high-temperature solution-phase chemical synthesis technique to achieve the precise composition and size control necessary for optimum placement of the Fermi energy level and avoid irregularly shaped particles. Also, further enhancements are made from creating modulated nanowire systems consisting of two different materials modulated by a well-defined period as well as in three-dimensional quantum-dot solids, which may accompany the formation of mini-bands in nanowires. These techniques improve upon prior art and provide enhanced ZT values.

Another feature of an embodiment of the present invention is the manipulation of nanocrystals (NCs) through a self-assembly process into the 1D pattern with high orientation order. A colloidal self-assembly is used in order to achieve 1D materials in diameters of quantum-confined limits. This strategy consists of preparing monodispersed NCs (including the synthesis and possible size-refinement), surface passivation, and pattern-organization (including self-organization of NCs at room temperature and possible post-annealing process). The self-organization of NCs involves various forces such as hydrogen bonding, dipolar forces, van der Waals forces, hydrophilic or hydrophobic interactions, chemsorption, surface tension and gravity in colloids. NCs can be, at room temperature, stable with respect to aggregation only if capping ligands provide a repulsive force of sufficient strength and range to counteract the inherent van der Waals attraction between NCs. Based on this mechanism, NCs suspended in a pairs of solvent/nonsolvent (e.g. the octane/octanol system) can be precipitated by a controlled-evaporation of the solvent from the mixture and eventually self-organized into close-packed and locally ordered 2D or 1D patterns.

Therefore an embodiment of the present invention accomplishes an in-situ self-assembly of NCs at high temperature to directly produce 1D nanomaterials and achieves a one-step preparation of PbSe 1D nanowires. Further alignment can be achieved by using a LB technique.

Other features relate to the preparation of nanopowder. In an embodiment of the present invention, a high-energy mechanical ball-milling process is used to break-down the potential thermoelectric materials into a submicro or nano-sized powder as a composite “matrix”. Mechanical Ball-milling, also referred to as mechanical attrition (MA), induces heavy cyclic deformation in powders and promotes the formation of nanostructures by the structural decomposition of coarser-grained structures. MA has been used to generate a variety of nanostructured powder materials, such as single-phase metals, ceramics, and compounds. Among the major advantages are its simplicity, the relatively inexpensive equipment (on the laboratory scale) needed, the applicability to essentially all classes of materials, and the possibility for easily scaling up to large quantities of materials for various applications. It is an effective processing method to synthesize nanostructured powders for various applications and is capable of alloying constituent elements at the atomic level. Also, “cryomiling”, represents a new development for the cost-effective synthesis of nanostructured particularly for alloys and composites. The cryomilling can further increase the synthesis efficiency and simultaneously minimize the oxidation of the milled materials.

Many semiconductor systems have been realized as promising thermoelectric candidates, such as PbTe, CsBi₄Te₆, and AgPb₁₀SbTe₁₂, CoSb₃ and Bi₂Te₃.

There are also features associated with processing into TE Bulk Material. In an embodiment of the invention, the nanowires and nanopowder may then processed into TE bulk material. This may be accomplished through ball milling or simply coating the nanopowder with the nanowires.

### Advantages of the Invention

The described embodiments of the invention have many advantages and applications including a high ZT, cost effectiveness as compared to otherwise creating TM bulk material, being simple to implement in only a handful of steps, scalability from small to large bulk TM material and in situ nanowire self assembly. Among the advantages associated with in situ nanowire self assembly are efficient production of high-yield nanowires with morphology-control, production of nanowires from an organic system without using either capping polymer or ionic surfactant as needed in traditional methods of synthesizing nanowires. Also, that one-dimensional (1D) nanoarrays can be prepared in one single step, exhibiting well-defined morphology, single-crystal-orientation and a clean surface without amorphous contamination. It is not required that all of the advantages be incorporated into every embodiment of the invention.

### Specific Embodiments and Examples

In one example of an embodiment of the present invention, a PbTe—PbSe thermoelectric nanocomposite is created via an in-situ Self-assembly of PbSe nanowires, preparation of the nanomaterial through Ball Milling, controlling the nanowire orientation, mixing the PbTe and PbSe materials and finally the formation of PbTe—PbSe nanowire enhanced bulk thermoelectric material.

First, PbSe nanowires are created through a high temperature in-situ self-assembly approach. A dynamic injection technique may be used to synthesize the PbSe nanowires from a PbSe high-temperature solution. The advantage of this method is that primary clusters can be replenished to keep a constant rate of the crystal growth by successively injecting additional solution of reagents, and thus the growth process can be monitored by collecting and analyzing a small portion of the reacting solution. This dynamic injection technique can be used in another embodiment of the present invention to create Mn-doped PbSe nanowires.

In one example, an organic solution in the presence of oleic acid and trioctylphosphine (TOP) is used as capping agents to stabilize the as-formed colloids. The PbSe formation occurs between lead acetate and trioctylphosphine selenium (TOPSe). Optionally, Pb(Ac)2.3H2O, phenyl ether, and oleic acid is mixed and heated to 150° C. for 30 minutes under an argon stream in a three-neck flask equipped with a condenser. After the solution is cooled to 40° C., it can be subsequently mixed with a certain amount of TOP—Se solution (1M for Se) in a glove box to form a stock solution.

After the first portion of such stock solution is rapidly injected into phenyl ether and pre-heated at around 200° C. for a certain period of time with agitation, a portion of the hot reaction mixture is extracted from the container and equal volumes of the pre-mixed stock solution of reagents is injected into the container under an argon stream. Dynamic injection can occur with an interval of every few minutes at a constant temperature. Each product can be retrieved from the original solvent by centrifugation, re-dispersed in toluene, and monitored. The average diameter and length of the 1D nanowires can be controlled to a range of 2 to 50 nanometers in diameter and 1-2 micrometers in length by finely tuning assembly temperature and growth time. Additionally, these PbSe nanowires can be doped with various elements by introducing different precursors to make them into either n-type or p-type materials.

Second, PbTe nanopowder is created via a high energy mechanical ball milling process. PbTe is used in this example as the bulk material due to its simple compositions and similar structure to PbSe. Minimization of impurity-contamination may call for ceramic ball instead of stainless steel balls to be used for ball milling. Furthermore, an Ar atmosphere may be used to avoid oxidation.

Third, the PbSe nanowires are properly oriented. After the synthesis of PbSe nanowires, a Langmuir-Blodgett (LB) assembly process may be used to align the synthesized PbSe nanowires into thin or thick films. Before the alignment, a suitable suspension condition by using a mixture of different surfactants is established in order to suspend the PbSe nanowires synthesized. Generally, surfactants consist of a hydrophilic (water soluble) group and a hydrophobic (water insoluble) part. There are four types of surfactants that can be used with a hexane/water system, including anionic surfactants, non-ionic surfactants, NP5, cationic surfactants, and amphoteric surfactant respectively. From experimentation, it is found that anionic surfactants (e.g. oleic acid) are the most favorable surfactant with hexane/water system, in which the as-synthesized PbSe nanowires could be stably suspended. Another reason to use oleic acid in the LB process also lies on the fact that in this example, nanowires were produced with anoleic acid as capping ligands, which means that the surface of the nanowires is covered with the oleic acid. Thereby, the nanowires easily “float” at the water/hexane interface.

The monolayer of PbSe nanowires is collected on NaCl thin film. After an annealing at an appropriate temperature, a second monolayer of PbSe nanowires will be deposited on the first PbTe layer on NaCl substrate. By following the same procedure, units of aligned PbSe nanowires are built until the thickness of the film is achieved to submicrometer.

NP5 or NP9 non-ionic surfactant may be used for building up highly organized multilayers of high-temperature grown nanowires. Monolayers of PbSe film can be formed by spreading the non-ionic surfactant NP5/NP9-toluene solution containing PbSe nanowires suspension at the surface of the water and through a pressure-induced operation. At low surface pressure, individual nanowires will form raft-like aggregates. These aggregates disperse on the subphase surface in a mostly isotropic state. The surface pressure remains unchanged until the nanowires start forming a monolayer and also when the monolayer is compressed to a certain amount of surface pressure. With further compression (increase of the surface pressure), nanowire assembly with symmetric arrangement is obtained. When the surface pressure is continuously increased to certain value, a transition from monolayer to multi-layer aligned PbSe nanowires is obtained. These Langmuir nanowires are eventually transferred onto substrates of a PbTe film. Low angle x-ray diffraction (XRD) and Atomic Force Microscopy (AFM) will also be employed to verify the layered deposition. In this example, film with a thickness of about 5-20 layers (each layer ˜10 nm) through layer-by-layer transfer is used. However, the ideal thickness may be optimized experimentally.

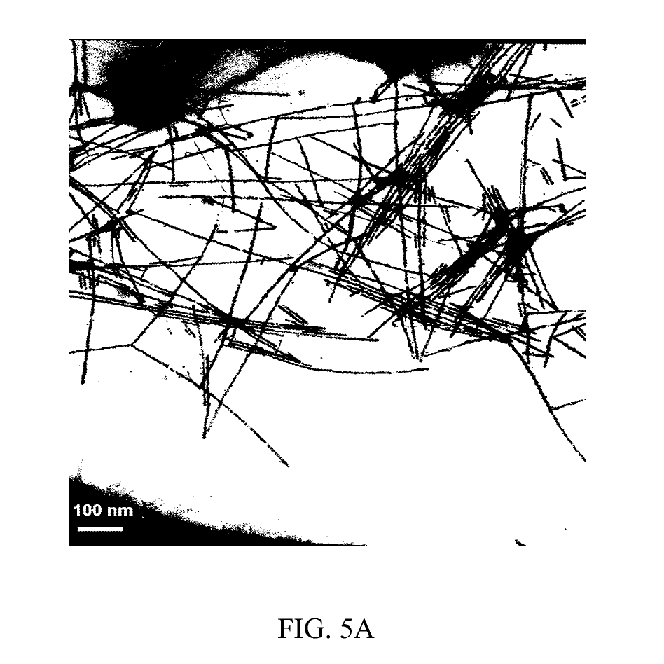

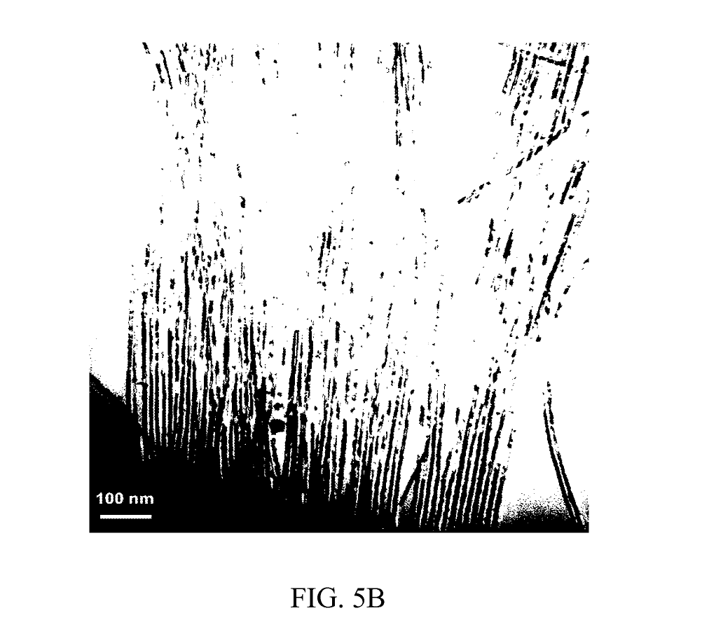

In one example, FIG. 5B illustrates a successful alignment of the PbSe nanowires. FIG. 5A is the TEM image of PbSe nanowires randomly synthesized. FIG. 5B is the TEM image of monolayer assembled PbSe nanowires using the L-B technique.

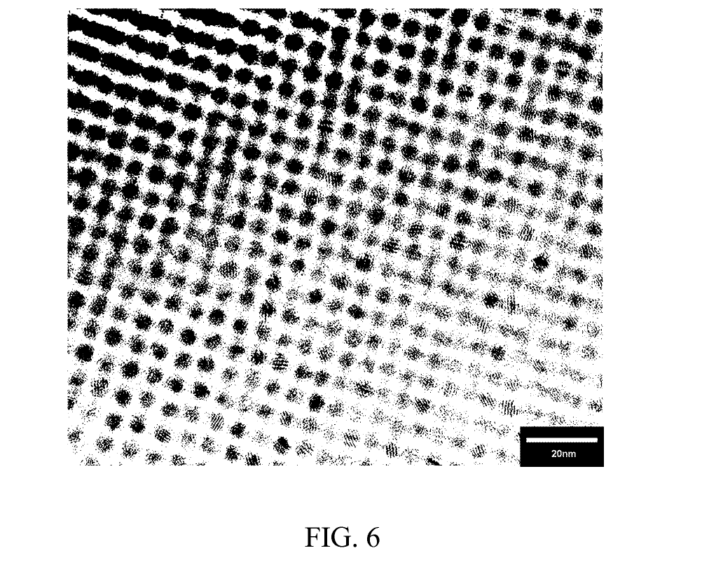

An alternative to the synthesis of nanowires is the synthesis of nanocrystals. However, any similar form may be used such as a nanotube or nanofiber. The exact nomenclature is not as important as the actual form. A wet-chemical solution approach is used to synthesize PbSe nanocrystals. In one approach among many possible approaches, a mixed solution, consisting of a Pb element (e.g.PbAc2) and Se element (e.g. TOP—Se), is rapidly injected into a vigorously stirred phenyl ether that then heated to certain temperatures (e.g. 200° C.), in which the chemical reaction temperature and crystalline growth is started. A size-selective precipitation may be subsequently performed by centrifugation, using a pair of solvents consisting of hexane and ethanol. The resultant PbSe nanocrystal is obtained, as shown in FIG. 6. The processing route is scalable for large-quantity synthesis.

Fourth, the PbTe and PbSe materials must be mixed, to synthesize a PbTe—PbSe nanocomposite. In one example, a high-energy mechanical ball milling under liquid nitrogen (cryomilling) is employed to break-down the potential thermoelectric materials into a submicro or nano-sized powder as our composite “matrix”. High-energy ball milling, which has a much higher ratio of milling balls/powders as compared with a conventional ball milling process, is an efficient means to generate a variety of nanostructured powder materials with such advantage as applicability to essentially all classes of materials and may be used for easy scaling from small to large quantities of materials. During the milling process, it induces heavy cyclic deformation in powders, which promotes (1) the formation of nanostructures by the structural decomposition of coarser-grained structures as a result of severe plastic deformation, and (2) penetration of nano-size particulates (nanoparticles) into the powders of other constituents, hence forming a nanocomposite in a single particle level. The introduction of liquid nitrogen into high-energy ball milling, in the “cryomilling” process, represents a new development for the cost-effective synthesis of nanostructured powders. The cryomilling can further increase the synthesis efficiency and simultaneously minimize the oxidation/contamination of the milled materials.

To avoid possible impurity-contamination in this milling approach elements (most likely the Fe) possibly introduced in the milling process, ceramic balls may be used instead of stainless steel ones. In addition, milling under an Ar atmosphere may be used to avoid possible oxidation.

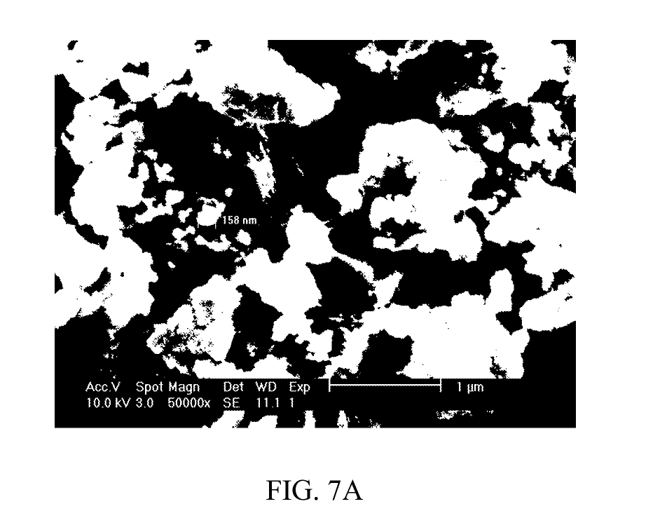

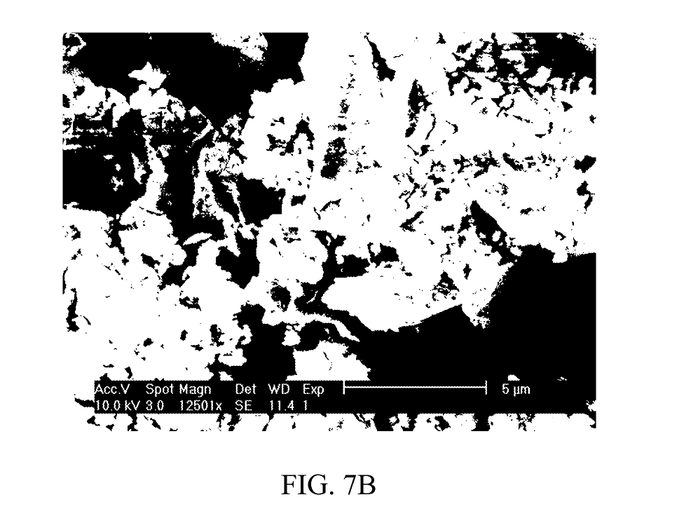

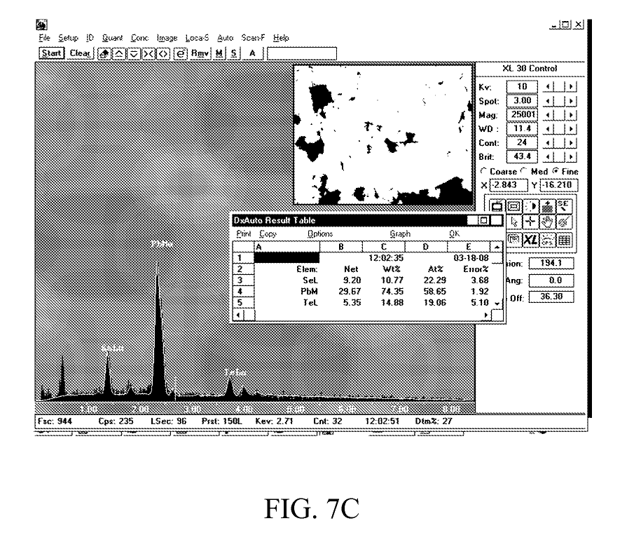

FIGS. 7A, 7B and 7C shows SEM microstructures of cryomilled PbSe powders and PbTe—PbSe along with energy dispersive spectrometer (EDS) for the element analysis. It is found the nano-sized particles and clusters of nano-sized particles form a complex “particle” in the dimension of several micrometers. The EDS for such cluster “particle” shows the element of Pb, Te and Se, indicating the formation of “composite” powders.

To process PbTe—PbSe nanocomposites as shown in FIG. 7B, one option is to cryomill the PbTe and PbSe powders together. Another approach is to produce the PbSe coating on the cryomilled PbTe powders.

Good thermoelectric characteristics have been observed when the successful fabrication of a nanocomposite in bulk form consisting of a randomly oriented assembly of nanoscale-sized or core-shell particles is available. This may be due to the altering of thermal/electrical properties owning to the introduction of nanoscale particles. In principle, the use of cryomilling can increase the mixing of nanoparticles, in which the nanoparticles can be penetrated into an individual unreinfocred matrix in a single particle level, forming a nanoparticle-reinforced nanocomposite powder or core-shell nanocomposite.

Finally, the material is formed as a nanowire enhanced bulk thermoelectric material. The mixture of aligned PbSe nanowires and PbTe powder is then transferred into a die system and alternately separated by layers of PbTe powders. A pellet consisting of PbTe bulk powder and units of PbSe nanowires will be fabricated by a hot-press compaction, such as hot isostatic processing (HIP) under an appropriate temperature, pressure and time.

For example, after cryomilling, high-purity PbTe—PbSe nanostructured powder mixtures are consolidated, using a high-pressure sintering process. As a set of examples for various embodiments, three kinds of PbTe—PbSe nanocomposites may be consolidated into bulk samples, such as: (1) PbTe(cryomilled particles)—PbSe(nanowire); (2) PbTe(cryomilled particles)—PbSe(nanocrystals); and (3) PbTe(cryomilled particles)—PbSe(cryomilled particles).

The percentage of PbSe nanowires in PbTe nanocomposite may directly affect thermoelectric performance. As an exemplary embodiment of the invention, two different concentrations of 2 wt. %, and 5 wt. % are used to demonstrate the increase of thermoelectric properties. Three sets of samples have been processed for consolidation, which include: (1) 2 wt % of cryomilled PbSe, 2 wt % of synthesized PbSe nanocrystals, and 2 wt % of synthesized PbSe nanowires were cryomilled with 98 wt % of PbTe powders (raw powder size in a range of several micrometers), respectively; (2) 5 wt % of cryomilled PbSe, 5 wt % synthesized PbSe nanocrystals, and 5 wt % of synthesized PbSe nanowires were cryomilled with 95 wt % of PbTe powders, respectively; and (3) 10 wt % of PbSe (cryomilled) were cryomilled with 90 wt % of PbTe powders. In addition, PbSe coating onto cryomilled PbTe powders form a PbSe (5 wt. %)—PbTe nanocomposite, with an aim of having a core (PbTe)-shell (PbSe) microstructure, was also sintered. As a comparison, a batch of cryomilled pure PbTe powders was also consolidated. The total materials consolidated are listed in Table 2.

TABLE 2
Compositions and Microstructures of PbTe-based
TE materials for consolidation

| PbTe | PbSe | Target Materials System |
|---|---|---|
| 100 | 0 | Nanostructured PbTe |
| 98 | 2*** | PbTe (cryomilled)-PbSe |
| | | (nanowire, nanocrystal, |
| | | cryomilled) nanocomposites |
| 95 | 5*** | PbTe (cryomilled)-PbSe |
| | | (nanowire, nanocrystal, |
| | | cryomilled) nanocomposites |
| 90 | 10 | PbTe (cryomilled)-PbSe (cryomilled) |
| | | nanocomposites |

*PbSe are in the three forms of nanowires, nanocrystals, and cryomilled particles respectively

Before consolidation, the cryomilled powers or powder mixtures are degassed in the vacuum (10⁻⁶ torr) to evacuate the potential trapped gas during the cryomilling process. The pressing of samples are carried out under a processing condition of 200 MPa, 340-500° C. and sintering time of 30-60 minutes in an Argon atmosphere. The resultant powders were then sintered into a bulk sample with nearly theoretical density, by controlling the sintering atmosphere, sintering temperature and sintering time.

This example as illustrated the processing steps to fabricate a large-dimension bulk samples. It is found that the sintering temperature required is much less than that for conventional PbTe or PbSe powders (e.g. 700-800 C for 4-6 hrs), and also avoid the potential problems that occur in the sintering of conventional PbTe or PbSe powders. For example, when the sintering temperature or time exceeded the optimum range, considerable volatilization of the component occurred, resulting in a decrease in the sintered density.

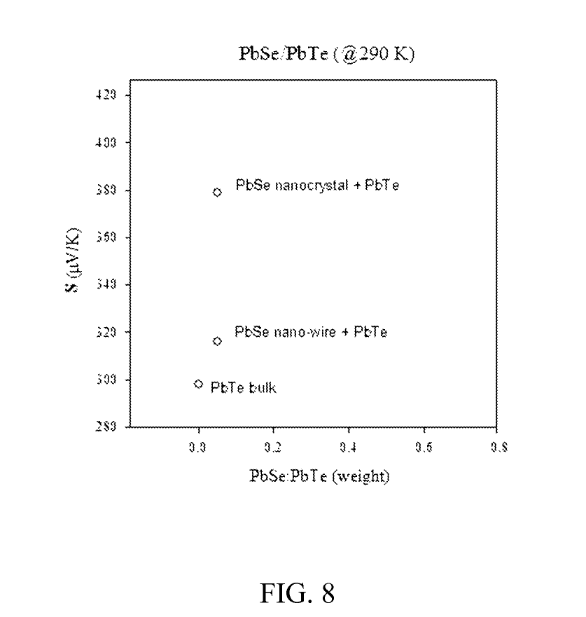

Exemplary embodiments and examples have also demonstrated that generally, an increase in the amount of nanowire, nanocrystal or nanotubes would increase the ZT values (ZT=S²T/ρk). In order to calculate ZT, several factors must be determined. The Seebeck coefficient (or themopower, S), Electrical resistivity (ρ), and Power factor (S²/ρ) are key important parameters in the equation of ZT(ZT=S²T/ρk). FIG. 8 illustrates the room temperature thermopower of various samples. Note that the addition of PbSe nanowire or nanocrystal of only 5% yields significant improvement in the S parameter, and therefore also increases the ZT value as well. Furthermore, a feature of the present invention includes a degree of control in the ZT value due to the ability to control the materials, dimensions and orientations of nanowires and nanopowder.

### Closing

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Thus, specific embodiments and applications of the present invention have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

What is claimed is:

1. A thermoelectric material comprised of:
a) a nanomaterial comprised of at least one form selected from the group consisting of
i. nanowires
ii. nanofibers,
iii. nanotubes, and
iv. nanocrystals; and
b) nanopowder.

2. The thermoelectric material of claim 1, wherein said nanomaterial comprises of up to and including 50% of said thermoelectric material.

3. The thermoelectric material of claim 2, wherein
a) said nanomaterial is comprised of at least one thermoelectric material; and
b) said nanopowder is comprised of at least one thermoelectric material.

4. The thermoelectric material of claim 3, wherein
a) said nanomaterial is comprised of at least one thermoelectric material selected from the group consisting of
i. PbTe,
ii. PbSe,
iii. Bi₂Te₃,
iv. Sb₂Te₃, and
v. Mn-doped PbSe; and
b) said nanopowder is comprised of at least one thermoelectric material selected from the group consisting of
i. PbTe,
ii. PbSe,
iii. CsBi₄Te₆,
iv. AgPb₁₀SbTe₁₂,
v. CoSb₃,
vi. Bi₂Te₃, and
vii. Sb₂Te₃.

5. A method of creating a thermoelectric material comprising:
a) a nanomaterial comprised of at least one form selected from the group consisting of
i. nanowires,
ii. nanofibers,
iii. nanotubes, or
iv. nanocrystals;
b) a nanopowder;
c) mixing said nanomaterial and said nanopowder;
d) consolidating said mixture of nanomaterial and said nanopowder into a solid.

6. The method of claim 5, wherein
a) said nanomaterial is chemically synthesized; and
b) said nanopowder is created by high energy ball milling.

7. The method of claim 6, wherein
a) said mixing is performed by cryomilling or to coat said nanopowder with said nanomaterial; and
b) said consolidation is prepared by hot isostatic pressing.

8. The method of claim 7, wherein said high energy ball milling is performed with ceramic balls and in an Ar atmosphere.

9. The method of claim 8, wherein said high energy ball milling is performed by cryomilling.

10. A thermoelectric module comprising:
a) a P and N type semiconductor composed of
i. a nanomaterial comprised of at least one form selected from the group consisting of
1. nanowires,
2. nanofibers,
3. nanotubes, and
4. nanocrystals; and
ii. nanopowder.

11. The thermoelectric module of claim 10, wherein said nanomaterial comprises of up to and including 50% of said thermoelectric material.

12. The thermoelectric module of claim 11, wherein
a) said nanomaterial is comprised of at least one thermoelectric material; and
b) said nanopowder is comprised of at least one thermoelectric material.

13. The thermoelectric module of claim 12, wherein
a) said nanomaterial is comprised of at least one thermoelectric material selected from the group consisting of
i. PbTe,
ii. PbSe,
iii. Bi₂Te₃,
iv. Sb₂Te₃, and
v. Mn-doped PbSe; and
b) said nanopowder is comprised of at least one thermoelectric material selected from the group consisting of
i. PbTe,
ii. PbSe,
iii. CsBi₄Te₆,
iv. AgPb₁₀SbTe₁₂,
v. CoSb₃,
vi. Bi₂Te₃, and
vii. Sb₂Te₃.
